(19) United States
(12) Patent Application Publication
(10) Pub. No.: US 2003/0203745 A1
(43) Pub. Date: Oct. 30, 2003

(54) Assisted base stations synchronization

(76) Inventors: Tung Ching Chiang, Berkeley Heights, NJ (US); Ren Da, Warren, NJ (US); Joseph Anthony Tarallo, Flanders, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/136,002

(22) Filed: Apr. 30, 2002

(51) Int. Cl. H04M 1/00

(52) U.S. Cl. 455/561; 455/502

(57) ABSTRACT

A method and apparatus for providing a base station with a timing reference that is precise and cost effective using assisting information to facilitate detection of, and extraction of system timing information from, satellite signals by the base station, thereby decreasing the intervals during which system timing information is unavailable and eliminating the need for a highly stabilized oscillator at the base station. Assisting information is any information which may be used by the base station to facilitate detection of satellite signals. Assisting information may include identities of satellites and satellite signal estimates, such as predicted navigation data, a Doppler frequency estimate, a code phase estimate, Doppler frequency and code phase search windows, etc. The satellite signal estimates are based on the known or current location of the base station.

### FIELD OF THE INVENTION

The present invention relates generally to wireless communications networks and, particularly, to synchronizing base stations in a wireless communication network.

### BACKGROUND OF THE RELATED ART

In wireless communication systems, communication between wireless terminals and one or more base stations is dependent upon time synchronization. If the timing between the wireless terminal and the base stations is not synchronized, communication between the wireless terminal and the base stations may be difficult or impossible. In the prior art, where a wireless terminal is in communication with a single base station, time synchronization between the wireless terminal and the base station is achieved using a base station timing signal, i.e., timing signal of the base station. Specifically, the base station transmits a base station timing signal to the wireless terminal which is used by the wireless terminal to synchronize its wireless terminal timing signal, i.e., timing signal of the wireless terminal. It is always the base station timing signal that is used to synchronize the wireless terminal timing signal. The wireless terminal timing signal is never used to synchronize the base station timing signal.

In the prior art, where a wireless terminal is in communication with a plurality of base stations, timing synchronization between the wireless terminal and each of the plurality of base stations is necessary. One manner of time synchronizing the wireless terminal with each of the plurality of base stations involves time synchronizing each of the plurality of base stations with each other and then time synchronizing the wireless terminal with at least one of the plurality of base stations.

A technique for time synchronizing the plurality of base stations with each other is to require each of the plurality of base stations to derive its timing signal using a common reference timing signal. One such common reference timing signal can be obtained from the well-known Global Positioning Satellite (GPS) system or some other satellite navigation system. The GPS system comprises of a constellation of GPS satellites that transmit GPS signals having system timing information, which may be used by base stations to synchronize themselves with other base stations.

Each of the plurality of base stations includes an antenna for receiving the GPS signals, and a receiver for detecting the GPS signals and extracting the system timing information from the detected GPS signals. The antenna should be mounted such that it has a clear or unobstructed view of the sky. Such a mounted antenna should be able to see all the GPS satellites over its horizon and receive GPS signals with a signal strength sufficiently strong to enable the receiver to detect the GPS signals.

In the prior art, the antenna can be mounted on a roof of an installation building so it has a clear view of the sky. Such roof mounted antenna is connected to the receiver via a coaxial cable. However, there are some problems associated with this type of installation. The receiver cannot be positioned too far from the roof because the length of the coaxial cable needs to be limited in order to minimize signal loss in the coaxial cable. If the receiver is positioned too close to the roof mounted antenna, the receiver becomes susceptible to being damaged by lightning. Additionally, the antenna can not always be installed on the roof of the installation building because the roof is unavailable or too costly.

To avoid the aforementioned problems associated with roof mounted antennas, the antenna can be mounted on the side of the installation building. Side mounted antennas, however, are associated with a different set of problems. In particular, the side mounted antenna probably will not be able to see all the GPS satellites over its horizon, and the signal strengths of the received GPS signals may not always be strong enough for the receiver to detect. Thus, for the GPS signals the antenna can receive, the receiver may not always be able to detect them in order to extract the system timing information. To ensure that the base station always has some type of timing reference, even when the receiver is unable to extract the system timing information from the GPS signals, the base station is equipped with an oscillator to provide a timing reference when the system timing information is unavailable.

With side mounted antennas, system timing information may be unavailable for extended intervals. To ensure the precision of the base station timing reference during these extended intervals, the oscillator needs to be highly stabilized. Highly stabilized oscillators are, however, very expensive. Thus, there exists a need for providing a base station with a timing reference that is precise and cost effective.

### SUMMARY OF THE INVENTION

The present invention is a method and apparatus for providing a base station with a timing reference that is precise and cost effective using assisting information to facilitate detection of, and extraction of system timing information from, satellite signals by the base station, thereby decreasing the intervals during which system timing information is unavailable and eliminating the need for a highly stabilized oscillator at the base station. Assisting information is any information which may be used by the base station to facilitate detection of satellite signals. Assisting information may include identities of satellites and satellite signal estimates, such as predicted navigation data, a Doppler frequency estimate, a code phase estimate, Doppler frequency and code phase search windows, etc. In a preferred embodiment, the satellite signal estimates are based on the known or current location of the base station. In one embodiment, the base station uses the assisting information to perform modulation data wipeoff based on the predicted navigation data, thereby increasing the sensitivity of the base station with respect to detecting satellite signals. In another embodiment, the base station uses the assisting information to search for satellite signals at or near a particular frequency and/or code phase based on the Doppler frequency estimate and/or code phase estimate, thereby facilitating the detection of the satellite signals by the base station.

### BRIEF DESCRIPTION OF THE DRAWINGS

The features, aspects, and advantages of the present invention will become better understood with regard to the following description, appended claims, and accompanying drawings where

FIG. 1 depicts a GPS system and a wireless communication network used in accordance with the present invention; and

FIG. 2 is a flowchart illustrating the operation of the wireless communication network in accordance with the present invention

### DETAILED DESCRIPTION

The present invention is a method and apparatus for providing a base station with a timing reference that is precise and cost effective using assisting information to facilitate detection of, and extraction of system timing information from, satellite signals by the base station, thereby decreasing the intervals during which system timing information is unavailable and eliminating the need for a highly stabilized oscillator at the base station. Assisting information is any information which may be used by the base station to facilitate detection of satellite signals. Assisting information may include identities of satellites and satellite signal estimates, such as predicted navigation data, a Doppler frequency estimate, a code phase estimate, Doppler frequency and code phase search windows, etc.

In a preferred embodiment, the satellite signal estimates are based on the known or current location of the base station. In one embodiment, the base station uses the assisting information to perform modulation data wipeoff based on the predicted navigation data, thereby increasing the sensitivity of the base station with respect to detecting satellite signals. In another embodiment, the base station uses the assisting information to search for satellite signals at or near a particular frequency and/or code phase based on the Doppler frequency estimate and/or code phase estimate, thereby facilitating the detection of the satellite signals by the base station.

The present invention will be described herein with reference to the well-known Global Positioning Satellite (GPS) system. This should not be construed to limit the present invention to the GPS system. It should be readily apparent to those of ordinary skill in the art that the present invention is equally applicable to any other satellite system from which timing information may be obtained.

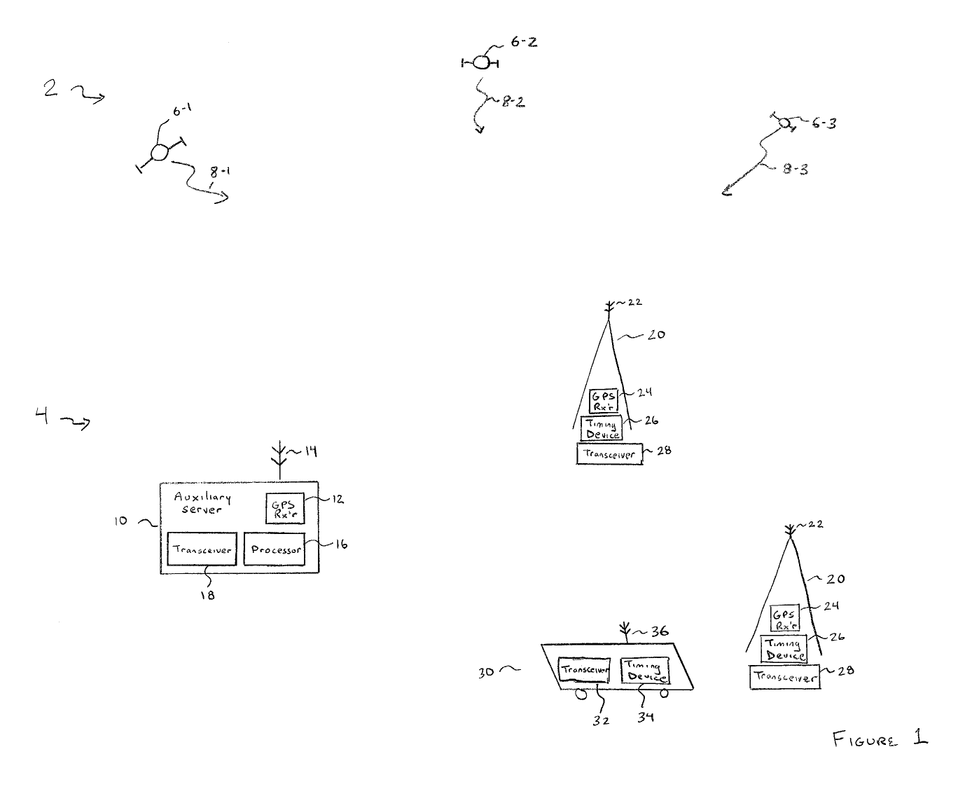

FIG. 1 depicts a GPS system 2 and a wireless communication network 4 used in accordance with the present invention. GPS system 2 comprises of a plurality of GPS satellites 6-j for transmitting GPS signals 8-j, which are carrier signals at a known frequency ƒ that have been bipolar phase shift key (BPSK) modulated using a unique pseudo-random noise code PN-j and navigation data ND-j associated with that particular GPS satellite 6-j. Pseudo-random noise code PN-j and navigation data ND-j are combined via modulo-two addition prior to modulating the carrier signal. Navigation data ND-j includes a satellite identifier, system timing information, satellite health indicators, orbital data and parity bits.

Wireless communication network 4 comprises an auxiliary server 10, a plurality of base stations 20, and a plurality of wireless terminals 30. Auxiliary server 10 is a server for providing base stations 20 with base station assisting information based on received GPS signals and locations associated with base stations 20. The base station assisting information is any information that may be used by base stations 20 to facilitate detection of GPS signals 8-j. In one embodiment, the base station assisting information includes identities of GPS satellites 6-j and associated satellite signal estimates, such as predicted navigation data ND-j, a Doppler frequency estimate, a code phase estimate, and search windows for the Doppler frequency and/or code phase. The identity of GPS satellites 6-j may be indicated using a GPS satellite identifier or a Pseudo-random noise code PN-j associated with the GPS satellite 6-j. Note that auxiliary server 10 may also be capable of providing wireless terminal assisting information to facilitate detection of GPS signals 8-j by wireless terminal 30.

Auxiliary server 10 comprises a GPS receiver 12 (or a GPS reference network comprising of a plurality of GPS receivers) to search for GPS signals 8-j, an antenna 14, a processor 16, and a transceiver 18. Antenna 14 is preferably mounted at a stationary and known location with a clear view of the sky. Processor 16 being operable to generate base station assisting information based on received GPS signals 8-j and locations of base stations 20 and wireless terminals 30. The base station assisting information is transmitted over a wireless or wired interface to base stations 20 by transceiver 18.

Each of the plurality of base stations 20 is operable to use the base station assisting information to detect GPS signals 8-j, and to provide communication services over a wireless interface to wireless terminals 30 located within a geographical area or cell associated with the base station 20. Each base station 20 comprises an antenna 22, a GPS receiver 24, a timing device 26, and a transceiver 28. Antenna 22 is mounted at a stationary and known location with or without a clear view of the sky. In an alternate embodiment, antenna 22 is mounted at a non-stationary or unknown location. GPS receiver 24 being operable to search for GPS signals 8-j in the absence of or in conjunction with base station assisting information. Timing device 26 being operable to generate a base station timing signal based on system timing information extracted from GPS signals 8-j. Transceiver 28 being operable to communicate with wireless terminals 30 over a wireless interface and with auxiliary server 10 over a wireless or wired interface. Note that each base station 20 may also include an oscillator, not shown, wherein such oscillator may not be highly stablized.

Each of the plurality of wireless terminals 30 comprises a transceiver 32, a timing device 34, and an antenna 36. Transceiver 32 being operable to communicate with base stations 20 and auxiliary server 10 over a wireless interface. Timing device 34 being operable to generate a wireless terminal timing signal that can be time synchronized with the base station timing signal. In one embodiment, timing device 34 is time synchronized with base stations 20 using base station timing signals. Alternately, wireless terminals 30 comprises a GPS receiver, not shown, which provides timing device 34 with system timing information such that timing device 34 can be time synchronized with base stations 20, or an oscillator for providing timing device 34 with a timing reference. Antenna 36 is typically in motion and/or in an unknown location with or without a clear view of the sky.

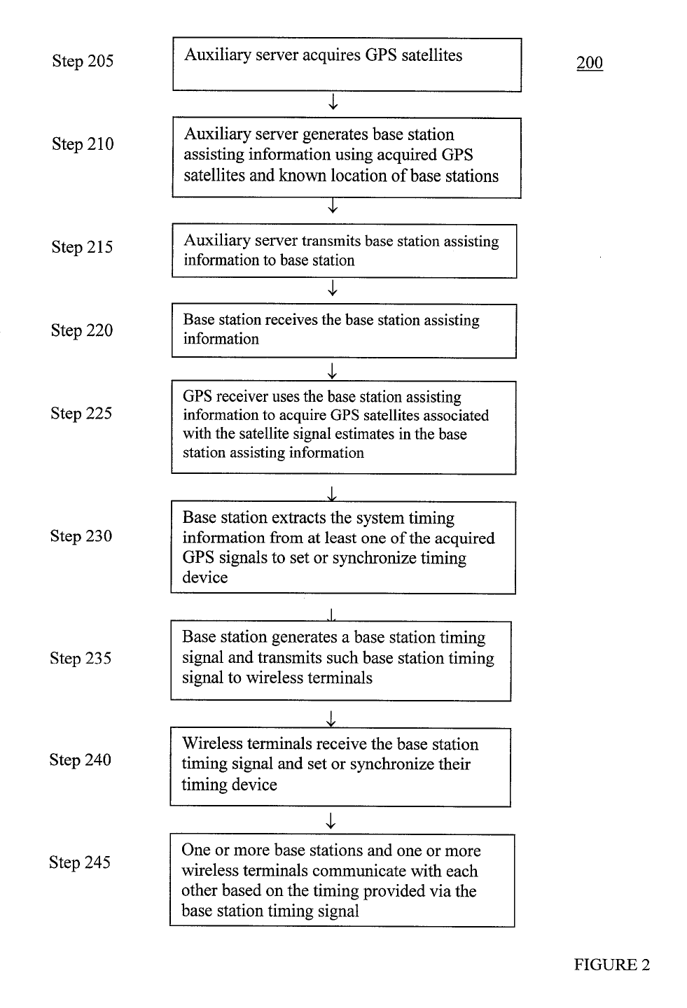

FIG. 2 is a flowchart 200 illustrating the operation of wireless communication network 4 in accordance with the present invention. In step 205, auxiliary server 10 acquires a plurality of GPS satellites 6-j, i.e., detects a plurality of GPS signals 8-j, using GPS receiver 12 via antenna 14. Auxiliary server 10 obtains the following information from each acquired GPS satellite 6-j: the identity of GPS satellite 6-j, navigation data ND-j, frequency ƒⱼ associated with GPS signal 8-j, and code phase PN-j, among other things.

In step 210, processor 16 uses the acquired information, i.e., information associated with the acquired GPS satellites 6-j, to generate base station assisting information. Specifically, processor 16 generates base station assisting information for each of the plurality of base stations 20 using the acquired information, the known locations of each antenna 22 and antenna 14 (or base station 20 and auxiliary server 10). The locations of each antenna 22 and antenna 14 (or base station 20 and auxiliary server 10) can either be known by processor 16 or be obtained by processor 16. In one embodiment, processor 16 determines satellite signal estimates, such as predicted navigation data ND-j, Doppler frequency ƒ_{Doppler-j} estimate, code phase of PN-j estimate, search windows for Doppler frequency ƒ_{Doppler-j} and/or code phase PN-j, or some combination thereof, associated with at least one of the acquired GPS satellites 6-j. The manner in which navigation data ND-j, Doppler frequency ƒ_{Doppler-j}, code phase PN-j, and search windows for Doppler frequency ƒ_{Doppler-j} and code phase PN-j are estimated are well-known in the art. The satellite signal estimates and, perhaps, the identities of GPS satellites 6-j associated with the satellite signal estimates collectively comprise the base station assisting information. In one embodiment, the identities of GPS satellites 6-j may be indicated using the associated unique pseudo-random noise code PN-j.

In another embodiment, processor 16 may also generate wireless terminal assisting information for wireless terminals 30. Wireless terminal assisting information differs from base station assisting information in the following manners. First, the base station assisting information includes satellite signal estimates based on a known location for antenna 22 or base station 20, whereas the wireless terminal assisting information may include satellite signal estimates based on a reference location for wireless terminal 30. The reference location is a location within a sector/cell in which wireless terminal 30 is currently located. The reference location is not the current location of wireless terminal 30, nor is the current location of wireless terminal 30 typically known. By contrast, the known location is the current location of antenna 22 or base station 20.

Second, base station 20 is only extracting system timing information from detected GPS signals 8-j, whereas wireless station 30 is performing location determination using the detected GPS signals 8-j. In order to extract system timing information, base station 20 need only to acquire a single GPS signal 8-j, thus, the base station assisting information need only include satellite signal estimates for a single GPS satellite 6-j. Preferably, the base station assisting information includes satellite signal estimates for at least two GPS satellites 6-j for redundancy purposes. By contrast, wireless terminal 30 needs to acquire at least three or more GPS signals 8-j in order to perform location determination, thus, the wireless terminal assisting information needs to include satellite signal estimates for at least three GPS satellites 6-j.

In step 215, auxiliary server 10 transmits the base station assisting information to base station 20. In step 220, base station 20 receives the base station assisting information via any proper communication link, which may be a wireless link using transceiver 28 via antenna 22 or via a landline link. In step 225, GPS receiver 24 uses the base station assisting information to acquire GPS satellites 6-j associated with the satellite signal estimates of the base station assisting information. In one embodiment, the predicted navigation data ND-j is used by GPS receiver 24 to remove the navigation data ND-j in, or perform modulation data wipeoff of, GPS signals 8-j in order to facilitate detection of GPS signals 8-j. In another embodiment, GPS receiver 24 searches for GPS signals 8-j at or near the Doppler frequency ƒ_{Doppler-j} estimate and/or code phase PN-j estimate.

In step 230, base station 20 extracts the system timing information from at least one of the acquired GPS signals 8-j and uses such system timing information to set or synchronize timing device 26. In step 235, base station 20 generates a base station timing signal via timing device 26, and transmits such base station timing signal to wireless terminals 30 periodically, sporadically or upon request. In step 240, wireless terminals 30 receives the base station timing signal and uses such base station timing signal to set or synchronize its timing device 34 (so that a wireless terminal timing signal may be generated that is synchronized with the base station timing signal). Alternately, wireless terminal 30 may use wireless terminal assisting information to acquire GPS satellites 6-j, extract system timing information from GPS signals 8-j associated with detected GPS satellites 8-j, and synchronize timing device 34 with the extracted system timing information. In step 245, one or more base station 20 and one or more wireless terminals 30 communicate with each other based on the timing provided via the base station timing signal (or system timing information extracted from GPS signals 8-j).

The present embodiment has been described herein with reference to certain embodiments. It should be understood that other embodiments are possible. Thus, the present invention should not be limited to the embodiments described herein.

We claim:

1. A method of time synchronizing base stations in a wireless communication network comprising the steps of:
receiving at least one satellite signal;
estimating satellite signal estimates for a base station using the received satellite signal and a known location for the base station; and
transmitting assisting information having the satellite signal estimates to the base station.

2. The method of claim 1, wherein the satellite signal estimates include at least a Doppler frequency estimate, a code phase estimate or predicted navigation data for a satellite associated with the received satellite signal.

3. The method of claim 1, wherein the assisting information includes an identity of a satellite associated with the satellite signal estimates.

4. The method of claim 1, wherein the satellite signal estimates are associated with only a single satellite.

5. The method of claim 1, wherein the satellite signal estimates are associated with only two satellites.

6. The method of claim 1 comprising the additional steps of:
receiving the assisting information; and
extracting system timing information from satellite signals detected using the assisting information.

7. The method of claim 6 comprising the additional step of:
generating a timing signal using the extracted system timing information.

8. The method of claim 7 comprising the additional step of:
transmitting the timing signal.

9. The method of claim 7 comprising the additional step of:
communicating with a wireless terminal using the timing signal.

10. A method of time synchronizing base stations in a wireless communication network comprising the steps of:
receiving assisting information at one or more base stations, the assisting information having satellite signal estimates based on received satellite signals and known locations for the one or more base stations; and
extracting system timing information from at least one satellite signal detected using the assisting information at the one or more base stations.

11. The method of claim 10, wherein the satellite signal estimates include at least a Doppler frequency estimate, a code phase estimate or predicted navigation data for a satellite associated with a satellite signal received by an auxiliary server.

12. The method of claim 10, wherein the assisting information includes an identity of a satellite associated with the satellite signal estimates.

13. The method of claim 10, wherein the step of extracting system timing information comprises the step of:
detecting the at least one satellite signal using predicted navigation the assisting information to perform modulation data wipeoff.

14. The method of claim 10, wherein the step of extracting system timing information comprises the step of:
detecting the at least one satellite signal using predicted navigation data in the assisting information to perform modulation data wipeoff.

15. The method of claim 10, wherein the step of extracting system timing information comprises the step of:
detecting the at least one satellite signal using a Doppler frequency estimate in the assisting information to search at or near a particular frequency.

16. The method of claim 10, wherein the step of extracting system timing information comprises the step of:
detecting the at least one satellite signal using a code phase estimate in the assisting information to search at or near a particular code phase.

17. The method of claim 10 comprising the additional step of:
generating a timing signal using the extracted timing signal.

18. The method of claim 17 comprising the additional step of:
communicating with a wireless terminal using the timing signal.

19. A base station comprising:
an antenna mounted at a stationary location for receiving assisting information;
a satellite receiver for detecting satellite signals using the assisting information and for extracting system timing information from detected satellite signals;
a timing device for generating a timing signal using extracted system timing information; and
a transmitter for transmitting signals using the timing signal.

20. The base station of claim 19, wherein the assisting information includes satellite signal estimates based on received satellite signals and the location of the antenna.
